(19) United States
(12) Patent Application Publication
(10) Pub. No.: US 2019/0340958 A1
(43) Pub. Date: Nov. 7, 2019

(54) NAIL COLOR SWATCH BOOK

(71) Applicant: Miho AZUMA, Osaka (JP)

(72) Inventor: Miho AZUMA, Osaka (JP)

(21) Appl. No.: 16/086,035

(22) PCT Filed: Mar. 29, 2017
(86) PCT No.: PCT/JP2017/013080

§ 371 Date: Sep. 18, 2018

(30) Foreign Application Priority Data
Apr. 14, 2016 (JP) 2016-081228

(51) Int. Cl. G09F 5/04; B42D 15/00

(52) U.S. Cl. CPC G09F 5/04; B42D 15/0093

(57) ABSTRACT

A nail color swatch book (1) includes: a plurality of swatch cards (2); and a binding member to bind the plurality of swatch cards (2) into one bundle. The swatch cards (2) each include a plurality of display parts (5) showing sample nail colors. The display parts (5) each have a shape imitating a human-nail shape, and are arranged so that bases of the human-nail like shapes make contact with a side edge part of each of the swatch cards (2). Respective center lines of the human-nail like shapes of each display part (5) in a height direction incline toward one direction relative to an edge line of the side edge part.

### TECHNICAL FIELD

The present invention relates to a nail color swatch book for displaying nail colors.

### BACKGROUND ART

As a method for decorating fingernails and toenails, gel nails using nail agents including photocurable resin are widely known, in addition to nail agents for manicure. The gel nail is made by applying a gel type nail agent onto the nail, curing the nail agent by light irradiation, and thus unifying the nail agent with the nail. The gel nails thus treated are hard and scratch-resistant compared to lacquer enamel for manicure. Thus, gloss and intense color of the gel nails last for a long time, which also serves as a protector of the nails. Also, since such beautiful nails give a sense of contentment, the gel nails have become very popular.

For example, Patent Document 1 discloses a general method for treating gel nail. In this method, normally, the surface and the tip of the nail are suitably shaped/prepared, and then each gel nail agent is applied and cured in the order of a base gel, a color gel and a top gel. As illustrated in FIG. 6, when the nail agent is applied, first, the center of a nail 101 in the width direction is brushed with the nail agent, and then the left side and the right side are respectively brushed, by a nail brush 102, along the longer direction of the nail 101. Through this normal method, the nail agent is applied over the entire nail 101 finely and evenly.

The color of the nail agent to be applied is determined by a practitioner (manicurist) in a nail salon or the like, normally, through the following procedures: asking a client as a person to be treated her/his preference/desire; and selecting an appropriate color among various nail agents, or mixing multiple different color nail agents to create a nail agent that matches the client's image. Sometimes, what color of the nail agent should be applied is determined by referring to nail design samples of nail tips on which various colors and/or designs are applied, or referring to photographs and the like exemplarily indicating the nail designs.

### PRIOR DOCUMENT

### Patent Document

Patent Document 1: JP 2015-189668 A

### SUMMARY OF THE INVENTION

Problem to Be Solved by the Invention

Since it is not easy to mix multiple nail agents to create a color that matches the client's image, it is preferable that the practitioner and the person to be treated view specific colors together and confirm the desired image with each other. However, it is time consuming to make samples of the nail colors such as nail tips and photographs, and furthermore, the number of the samples is limited. In contrast, an enormous number of colors can be created by mixing nail agents.

For example, the color simply called “pink” actually covers many kinds of colors. For example, in addition to pink colors having difference in hue such as bluish pink and yellowish pink, there are also: pink colors with high lightness such as pale tone pink or light tone pink; vivid and pure pink colors; and dusky pink colors. When one color or multiple colors should be determined for the treatment among such an enormous number of nail colors, verbal interaction between the practitioner and the person to be treated is not sufficient to convey/understand their mutual intentions, apart from the fact that it is time consuming. For this reason, there needs to be a simple tool to determine the nail color, which is easy to see and to handle for both the practitioner and the person to be treated.

Furthermore, since the skin color and tone differ among the people, it is desired to provide not only her/his favorite nail color, but also a basis for decision and a material for consideration so as to determine what kind of nail color looks good on the person to be treated, i.e. what kind of nail color make the fingernails and/or the toenails of the person to be treated look beautiful.

The present invention was made in consideration of the above problems, an object of which is to provide a nail color swatch book that is easy to handle when performing the nail art treatment and that is suitable for determination of the color of the nail agent to be applied.

### Means for Solving the Problem

In order to achieve the above object, a nail color swatch book that shows nail colors in the present invention includes: a plurality of sheet-like swatch cards; and a binding member binding the plurality of swatch cards into one bundle. The plurality of swatch cards each includes a plurality of display parts that shows sample nail colors. The plurality of display parts each has a shape imitating a human-nail shape, and is arranged along a side edge part of each of the swatch cards. Furthermore, respective bases of the human-nail like shapes of the display parts are arranged so as to make contact with the side edge part of each of the swatch cards while respective center lines of the human-nail like shapes in a height direction are disposed so as to incline relative to an edge line of the side edge part of each of the swatch cards.

With the above-described configuration, it is possible to pick up and see many sample nail colors. Thus, the nail color swatch book can be handled without difficulty when the nail art treatment is performed. Also, since the nail design can be easily imaged by putting the display parts on the nails, the above-described configuration is suitably used to determine the nail agent to be applied. Furthermore, the display parts of the swatch card are arranged so as to be readily fit to the nails, which also contributes to easiness in handling.

Also, in the present invention, a nail color swatch book that shows nail colors includes: a plurality of sheet-like swatch cards; and a binding member binding the plurality of swatch cards into one bundle. The plurality of swatch cards each includes a plurality of display parts that show sample nail colors. The plurality of display parts each has a shape imitating a human-nail shape, and is arranged along a side edge part of each of the swatch cards. The display parts on each of the swatch cards indicate different hues in the same lightness or the same saturation. The plurality of swatch cards is overlapped and bound one by one in the order of the lightness or the saturation of the display parts.

Alternatively, the display parts on each of the swatch cards indicate different hues in a same tone. The plurality of swatch cards is piled up to be bound so that the swatch cards similar to each other in the tone of the display parts are sequentially overlapped.

The display parts may be disposed so as to each have a convex shape on a surface side of each of the swatch cards while concave parts are disposed on a reverse surface side of the display parts so that fingertips are fit to the concave parts. With this configuration, it is possible to more easily image the nail color to be applied onto the nails by putting the fingertips under the concave parts of the swatch card.

Also, the ground part of the swatch card may be transparent or semi-transparent. In this way, when the nails are put under the display parts, the fingertips can be seen from the part surrounding the display parts, which further serves to image the specific nail color/design.

Also, in the above-described nail color swatch book, the sample nail colors on the display parts are classified and collected, for every bundle of the swatch cards, into one of four season groups constituted by a spring group, a summer group, an autumn group and a winter group. In this way, it is possible to propose or consider a nail color that particularly suits the person to be treated.

### Effects of the Invention

The nail color swatch book of the present invention is simple and easy to handle when the nail art treatment is performed, which is suitably used as a basis for decision and a material for consideration in order to determine the color of the nail agent to be applied.

### BRIEF DESCRIPTION OF THE DRAWINGS

FIG. 1 is a plan view illustrating a nail color swatch book according to a first embodiment of the present invention.

FIG. 2 is an explanatory view illustrating an example of use of the nail color swatch book.

FIGS. 3(a) to 3(d) are plan views illustrating respectively the nail color swatch books according to a second embodiment. FIG. 3(a) shows a swatch card belonging to a spring group. FIG. 3(b) shows a swatch card belonging to a summer group. FIG. 3(c) shows a swatch card belonging to an autumn group. FIG. 3(d) shows a swatch card belonging to a winter group.

FIGS. 4 are plan views illustrating respectively the nail color swatch books according to a third embodiment of the present invention.

FIGS. 5(a) and 5(b) are plan views illustrating respectively swatch cards of the nail color swatch books according to a fourth embodiment of the present invention.

FIG. 6 is a plan view illustrating the nail color swatch book according to another embodiment.

FIG. 7 is a perspective view illustrating a swatch card and a ring of the nail color swatch book according to another embodiment.

FIG. 8 is an explanatory view illustrating a conventional gel nail treatment method.

### MODE FOR CARRYING OUT THE INVENTION

Hereinafter, a nail color swatch book according to embodiments of the present invention will be described with reference to the drawings.

### First Embodiment

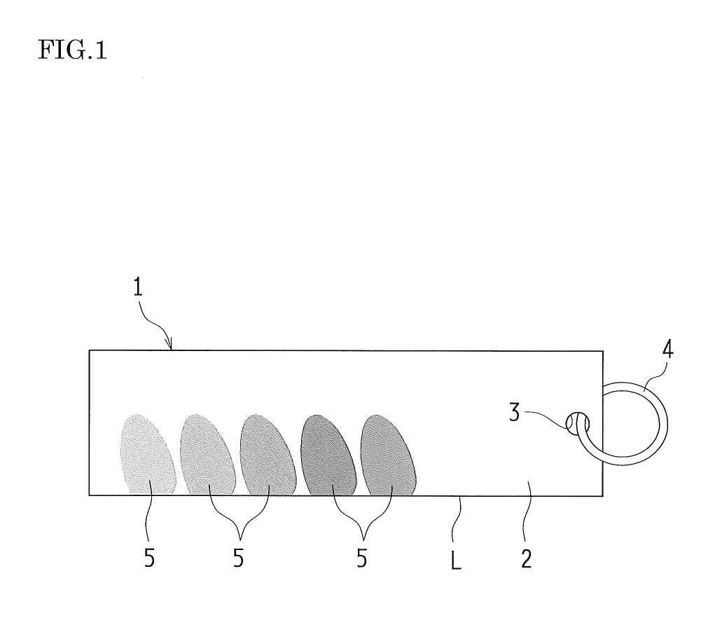

FIG. 1 is a plan view illustrating a nail color swatch book 1 according to the first embodiment. The nail color swatch book 1 includes: a plurality of sheet-like swatch cards 2; and a binding member that binds the plurality of swatch cards 2 into a bundle.

The swatch card 2 is a sheet-like material having a strip shape, which is made of paper or a plastic sheet having appropriate thickness and flexibility, and further having high print reproducibility. A round hole 3 is disposed in one end of the swatch card 2, into which a ring 4 is inserted to serve as a binding member of the swatch card 2. The plurality of swatch cards 2 is piled up in the same direction, and bound, by the ring 4 inserted into the respective round holes 3, into a bundle.

On the swatch card 2, display parts 5 are formed so as to show sample nail colors. The ground part of the swatch card 2 (i.e. the part other than the display parts 5) has a white color. The plurality of display parts 5 is arranged along a side edge part of the swatch card 2. Each of the display parts 5 has a human-fingernail shape, which imitates the shape and size of human fingernail.

The display parts 5 are arranged along the longer direction of the swatch card 2. In the display parts 5, respective bases of the fingernail shapes are arranged so as to make contact with a side edge part (edge line L) of the swatch card 2 in the longer direction while respective tips of the fingernail shapes are arranged so as to incline toward one direction on the swatch card 2.

In the swatch card 2 as exemplarily illustrated in FIG. 1, a short-strip like swatch card 2 is used with its longer side in the horizontal direction. Thus, in its longer direction (left and right direction), five (5) display parts 5 are arranged at constant intervals. The swatch card 2 is provided with the round hole 3 on the right side in FIG. 1, into which the ring 4 is inserted. The display parts 5 are arranged so that respective center lines of the fingernail shapes in the height direction incline relative to the edge line L of the side edge part of the swatch card 2 in the longer direction. Thus, the display parts 5 are slightly inclined toward the left direction in FIG. 1.

The sample nail colors are shown as the five (5) display parts 5 on one swatch card 2, based on a certain rule such as difference in lightness, difference in saturation, or difference in tone, within a particular hue. For example, on the swatch card 2 in FIG. 1, the sample nail colors are shown, which differ from one another in lightness in the same hue. More specifically, the lightness of the sample nail colors printed on the swatch card 2 becomes gradually higher from the display part 5 disposed on the right side to the display part 5 disposed on the left side.

In this way, the five (5) different sample nail colors in a particular hue are shown on one swatch card 2. The arrangement of the display parts 5 is made similar to the inclination of the fingers and nails when the back of the left hand is stretched out in front of the body.

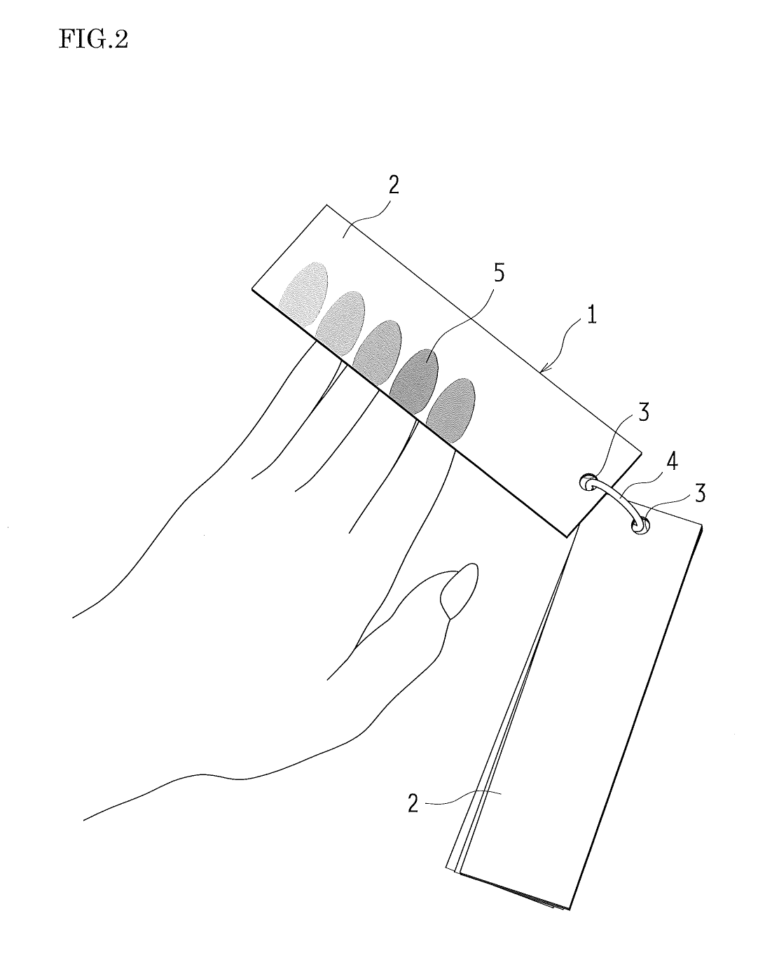

As illustrated in FIG. 2, one swatch card 2 showing a particular hue is selected from the nail color swatch book 1. The swatch cards 2 are held with the right hand and the selected swatch card 2 is put on the nails of the left hand. Like this, when the display parts 5 of the swatch card 2 are put on the nails of the left hand, the display parts 5 are just aligned along the direction of the fingers. Thus, it is possible to put the display parts 5 of the swatch card 2 on the fingers of a person to be treated without difficulty in a comfortable position.

In this way, when determining what kind of the nail color should be selected, it is possible to put the selected one swatch card 2 on the fingertips instead of simply looking at the nail color swatch book 1. Thus, every display parts 5 can be put on the fingers one by one, which makes possible to select a desirable nail color or to determine whether the color is an appropriate color or not.

When the nail color is selected, sometimes it is preferable that a plurality of different sample nail colors in similar hues are compared to one another. Thus, in addition to the sample nail colors in the same hue that are shown on one swatch card 2, the sample nail colors shown on one swatch card 2 may differ from one another, for example, in lightness or in saturation in the similar hues.

That is, the sample nail colors appeared in one nail color swatch book 1 are preferably shown as the display parts 5 on the swatch cards 2 based on a certain rule such as the following:
(1) The sample nail colors of the display parts 5 are arranged, for every swatch card 2, so as to each have a lightness different from one another in a particular hue or similar hues. In this case, the side edge part (edge line L) of the swatch card 2 corresponds to the lightness axis, and the lightness increases or decreases in the arrangement direction of the display parts 5;
(2) The sample nail colors of the display parts 5 are arranged, for every swatch card 2, so as to each have a saturation different from one another in a particular hue or similar hues. In this case, the side edge part (edge line L) of the swatch card 2 corresponds to the saturation axis, and the saturation increases or decreases in the arrangement direction of the display parts 5; and
(3) The sample nail colors of the display parts 5 are arranged, for every swatch card 2, so as to each have a tone different from one another in a particular hue or similar hues. In this case, the side edge part (edge line L) of the swatch card 2 corresponds to the color tone axis, and the colors having similar tones are arranged as two display parts 5 adjacent to each other.

In contrast to the display parts 5 showing the sample nail colors, the sheet-like material of the swatch card 2 as the ground of the display parts 5 has preferably white color so that the colors can be easily seen. When the swatch card 2 is made of a plastic sheet or the like, the swatch card 2 may be made of a transparent or semi-transparent plastic sheet-like material so as to emphasize the colors of the display parts 5. Since the swatch card 2 is transparent or semi-transparent, the skin color can be seen from the part surrounding the display parts 5 when the display parts 5 are put on the fingertips. Thus, it is easy to confirm whether the color looks good on the skin or whether it is the color just as imaged, which further serves to select/determine the nail color.

The multiple swatch cards 2 having similar hues are overlapped with one another and bound at one part of their ends, thus they are bound into one nail color swatch book 1. The multiple swatch cards 2 can be rotated about the round hole 3 so as to be spread out in the arc shape. On thus spread swatch cards 2, the multiple display parts 5 are aligned, on the circumference having the same radius, so as to have a gradation of the hues similar to one another. In this way, it is possible to readily select a desirable color among the many sample nail colors. Based on the selected sample nail color, the practitioner selects the nail agent or mixes the multiple nail agents so as to easily create the nail color to be applied.

Also, on the swatch card 2, the display parts 5 can be arranged so as to each have a different hue in the same lightness or the same saturation. The multiple swatch cards 2 may be overlapped and bound in the order of the lightness or saturation of the display parts 5 so as to constitute the nail color swatch book 1.

On the display parts 5, the sample nail colors are printed and shown. However, if the swatch card 2 is made of a plastic sheet-like material, the method for showing the sample nail colors is not limited to printing. The sample nail colors may be shown as the nail agents themselves applied on the swatch card 2. Regarding the binding member, it is not limited to the configuration including the round hole 3 and the ring 4. Binding members such as various types of fixtures or binding tools may be used. Also, the multiple swatch cards 2 may be bound in a bookbinding manner.

### Second Embodiment

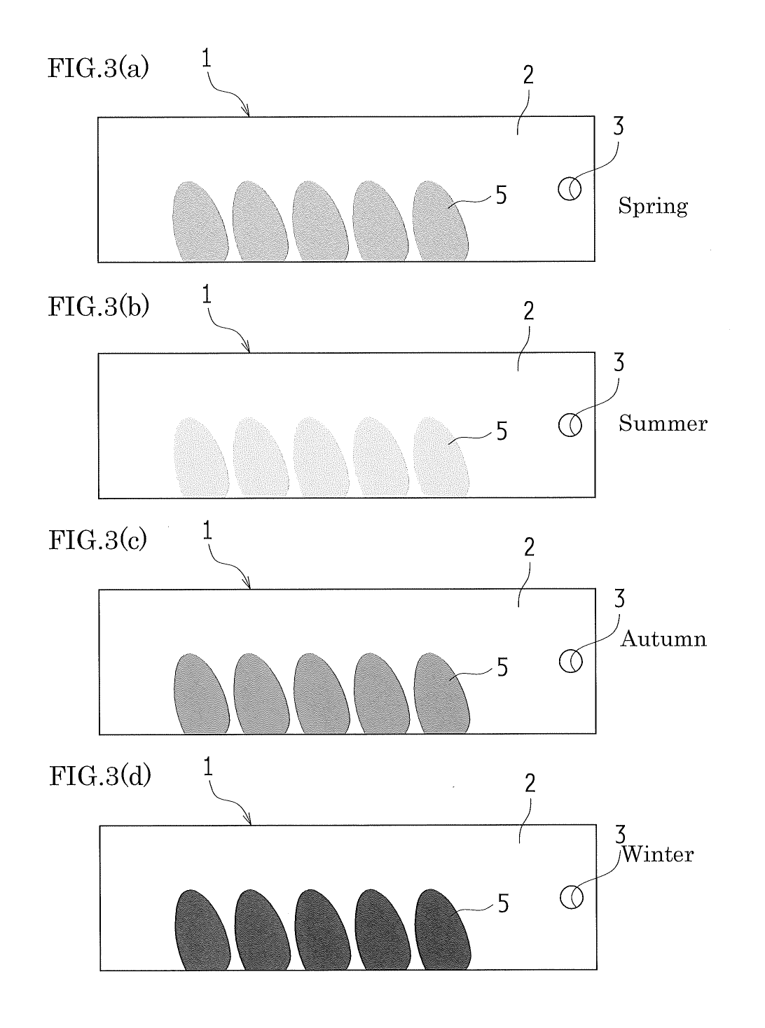

FIGS. 3(a) to 3(d) are plan views illustrating other examples of the swatch cards 2 constituting the nail color swatch books 1 according to the second embodiment. The embodiment of the nail color swatch books 1 described below has a basic configuration in common with that of the first embodiment. Thus, detailed description on respective elements is omitted while characteristic features of this embodiment will be described.

In this embodiment, five (5) display parts 5 are arranged on the short-strip like swatch card 2, along the side edge part in the longer direction. The arrangement of the five (5) display parts 5 is also made similar to the state of the fingertips when the back of the hand is naturally stretched out.

Depending on original colors of nails and skin of a person to be treated, there seems to be nail colors that look good on her/him and that do not look good on her/him. That is, everyone has a group of colors that suits her/him depending on her/his apparent color characteristics, i.e. colors of skin, hair, eyes, lips and the like. Such a group of colors is generally called as “personal colors”. Thus, in the nail color also, there seems to be colors that are in harmony with and look good on the person to be treated depending on her/his skin color of the fingertips and the back of the hand.

The sample nail colors on the display parts 5 of the swatch card 2 are shown based on a certain rule. In the examples illustrated in FIGS. 3(a) to 3(d), the sample nail colors are grouped so as to make respective nail color swatch books 1.

Specifically, the sample nail colors shown on the display parts 5 are classified and grouped into one of “four season groups” in the personal colors for every nail color swatch book 1. As respective examples of such nail color swatch books 1, FIG. 3(a) shows a swatch card 2 that is grouped into a spring group, FIG. 3(b) shows a swatch card 2 that is grouped into a summer group, FIG. 3(c) shows a swatch card 2 that is grouped into an autumn group, and FIG. 3(d) shows a swatch card 2 that is grouped into a winter group. For every group of the swatch cards 2, the sample nail colors that belong to the corresponding group are shown. Thus, the above four (4) kinds of nail color swatch books 1 constitute one set of nail color swatch books 1.

Each number of the sample nail colors that belong to the corresponding group is, for example, 39 colors in the spring group, 43 colors in the summer group, 41 colors in the autumn group and 36 colors in the winter group. Thus, the number differs from one another. Therefore, the number of the swatch cards 2 that are bound to make one nail color swatch book 1 also differs depending on the group.

For example, in the single swatch card 2 in FIG. 3(b), one of the sample nail colors that belong to the summer group is shown on the five display parts 5. That is, in this embodiment, the five (5) display parts 5 show the same sample nail color, because any change in the lightness or the saturation in a particular hue generates a nail color that belongs to another group.

For making the four season groups, for example, the hues of the colors such as red, orange, yellow, green, blue and purple are classified into four groups of sample nail colors (namely, the spring group, the summer group, the autumn group and the winter group) based on undertone, lightness, saturation and clearness/turbidity. When selecting the nail color, it is possible to select, for each person to be treated, the nail color swatch book 1 that belongs to any of the four groups based on the above classification into the four season groups in the personal colors.

The nail colors collected in the selected nail color swatch book 1 are the colors that look good on the person to be treated. Thus, it is possible to determine the color by putting, on the nails, the card on which the desirable color is shown. Such selected nail color not only suits the person to be treated, but also makes her/his nails and fingers/toes more beautiful. Thus, it is possible to create the nail design that pleases many people and gives them a good impression. Regarding a method for diagnosing the personal colors, it is possible to use various publicly-known methods that have been proposed.

### Third Embodiment

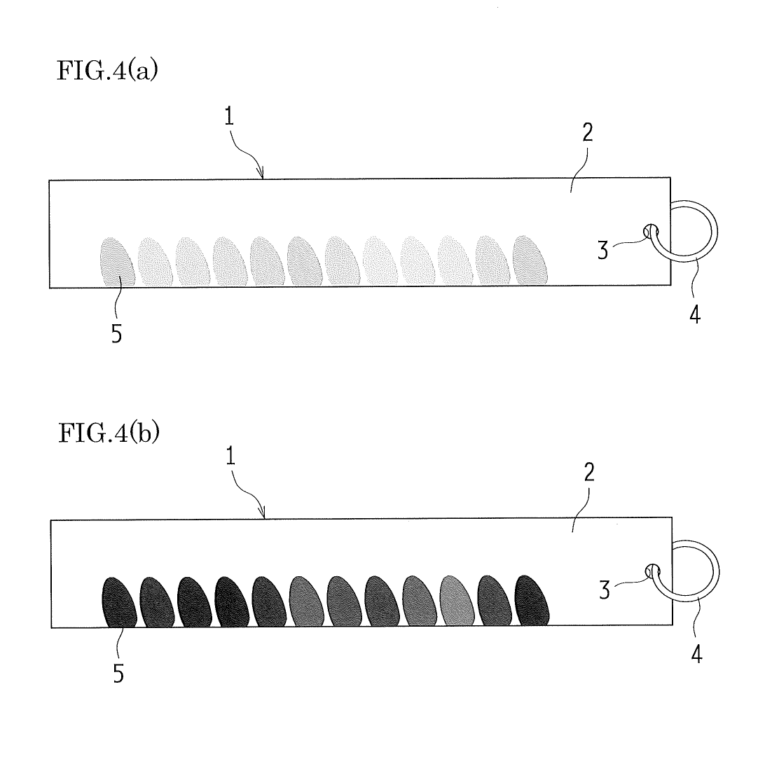

FIGS. 4(a) and 4(b) are plan views illustrating one set of nail color swatch books 1 according to the third embodiment.

In the nail color swatch book 1, the number of the display parts 5 arranged on one swatch card 2 is not limited to 4 or 5. A greater number of display parts 5 may be disposed. In this way, it is possible to show a subtler difference in the color on one swatch card 2.

As illustrated in FIGS. 4(a) and 4(b), in the nail color swatch book 1 according to the third embodiment, twelve (12) display parts 5 are arranged on one swatch card 2. On these twelve (12) display parts 5, the different hues in the same tone (or in the similar tones) are shown. The hues shown on the display parts 5 are blue, blue green, green, yellow green, yellow, yellow orange, orange, red orange, red, red violet, violet, and blue violet, which are arranged so as to be adjacent to one another in this order.

For example, on the swatch card 2 illustrated in FIG. 4(a), twelve (12) hues in the pale tone are arranged sequentially. On the other hand, on the swatch card 2 illustrated in FIG. 4(b), twelve (12) hues in the dark grayish tone that is opposite to FIG. 4(a) are arranged sequentially. Thus, on one swatch card 2, twelve (12) display parts 5 are arranged so that two resemble hues in closely similar lightness and saturation are arranged adjacent to each other.

In order to be bound into one nail color swatch book 1, the multiple swatch cards 2 are piled up so that the swatch cards 2 similar to each other in the tone level of their display parts 5 are sequentially overlapped and bound. Specifically, regarding the tones of the display parts 5 on the respective swatch cards 2 of the nail color swatch book 1, seventeen (17) kinds of tones similar to one another are overlapped to be bound in the order of: very pale tone (vp); pale tone (p); pale grayish tone (pg); middle grayish tone (mg); light grayish tone (ltg); light tone GO; soft tone (sf); bright tone (b); vivid tone (v); strong tone (s); deep tone (dp); dull tone (d); dark tone (dk); grayish tone (g); very grayish tone (vg); dark grayish tone (dkg); and very dark tone (vdk). Thus, the tone level of the colors on the display parts 5 of the swatch card 2 positioned at the top of the nail color swatch book 1 contrasts with the tone level of the colors on the display parts 5 of the swatch card 2 positioned at the bottom of the nail color swatch book 1.

In the embodiment illustrated in FIGS. 4, two different nail color swatch books 1 are indicated. In one of the nail color swatch books 1, the swatch cards 2 are bound so that the color tone level gradually lowers in lightness and in saturation from the top, i.e. they are bound, from the top, in the order of: very pale tone; pale tone; pale grayish tone; ( . . . ); dark grayish tone; and very dark grayish tone. In the other one of the nail color swatch books 1, the swatch cards 2 are bound so that the color tone level gradually rises in lightness and in saturation from the very dark tone to the very pale tone from the top, i.e. they are bound, from the top, in the inverse order of the one nail color swatch book 1. That is, in the two nail color swatch books 1, the multiple swatch cards 2 are piled up in the respective orders of the color tone level that are reverse to each other.

As illustrated in FIGS. 4, in the two nail color swatch books 1, twelve (12) display parts 5 are arranged so that, when the same pages of the respective swatch cards 2 are vertically aligned, the opponent (contrast) sample nail colors are respectively arranged on the upper and lower display parts 5. That is, the sample nail color shown on the display part 5 at the left end of the swatch card 2 in FIG. 4(a) is an opposing color to the sample nail color shown on the display part 5 at the left end of the swatch card 2 in FIG. 4(b).

With the above configuration, by using at the same time these two nail color swatch books 1 as one set, it is possible to compare the hues having a contrast relationship or having a similarity relationship in tone on respectively the same pages of the swatch cards 2 arranged side by side. Also, it is possible to find immediately the opposing color to a particular hue. Thus, it serves very much to figure out/consider the nail design.

Generally, the arrangement of the hues whose tone levels have a contrast or similarity relationship is harmonious while the hues having considerable difference in tone or the opposing colors highlight or accentuate each other. Therefore, when a plurality of nail colors to be applied is selected, the above one set of the nail color swatch books 1 can be suitably used, and furthermore, it serves to build a specific image when the nail design is determined.

On the display parts 5 of the swatch card 2 of the nail color swatch book 1, different hues in the same lightness or the same saturation may be shown. In this case, a plurality of swatch cards 2 is piled up and bound in the order of greatness (smallness) in lightness or saturation of the display parts 5 so as to make a bundle of nail color swatch book 1.

### Fourth Embodiment

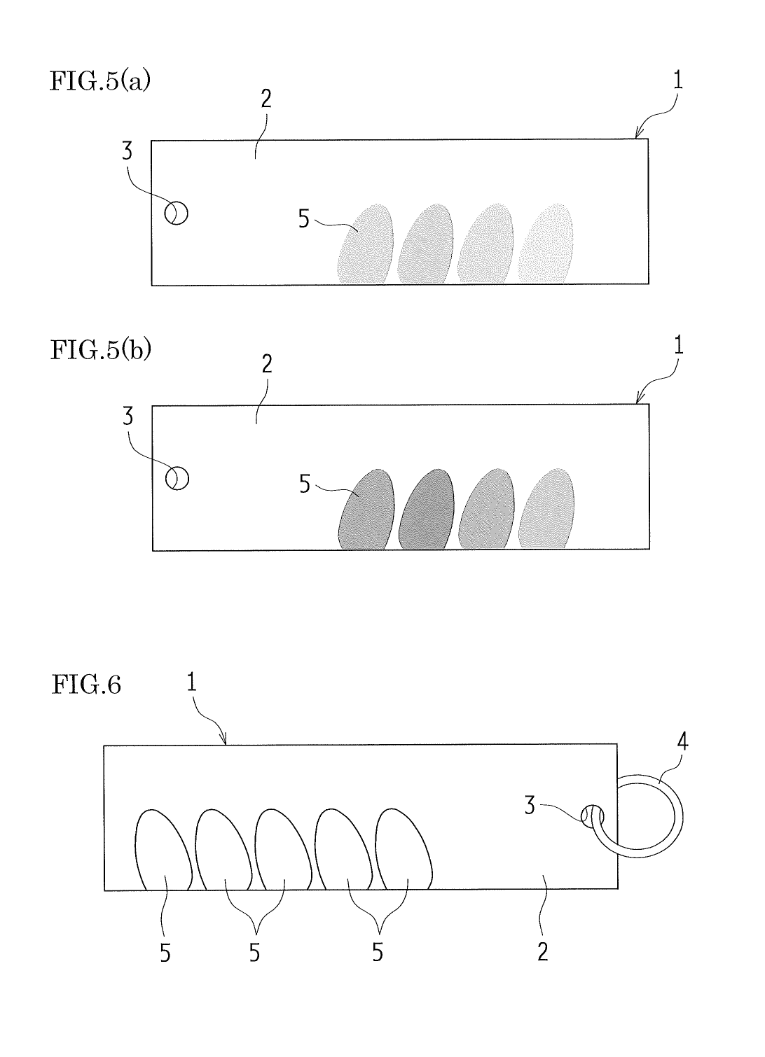

FIGS. 5(a) and 5(b) are plan views illustrating the nail color swatch book 1 according to the fourth embodiment.

In the previous embodiments, the ring 4 is disposed at the right end of the swatch cards 2 taking into account the right hand as the dominant hand. In contrast, the ring 4 may be disposed at the left end so as to put the display parts 5 on the right hand (foot). In this case, as illustrated in FIGS. 5, the display parts 5 are also inclined toward an opposite direction to the direction of the previous embodiments.

There are four (4) display parts 5 arranged on the swatch card 2. When the display parts 5 of the swatch card 2 are put on the fingernails of the right hand, the display parts 5 are aligned as if the four fingertips of the right hand other than the thumb were put along the side edge part of the swatch card 2.

On the four display parts 5, the sample nail colors that match the skin colors of the Japanese are shown. In the nail color swatch book 1 as illustrated in FIG. 5(a), the sample nail colors belonging to the beige tone group are collected. In the nail color swatch book 1 as illustrated in FIG. 5(b), the sample nail colors belonging to the gray tone group are collected.

The sample nail colors in the beige tone group are colors made by adding beige to the hues in vivid tone. The sample nail colors in the gray tone group are colors made by adding gray to the hues in vivid tone. On the four (4) display parts of each swatch card 2, the sample nail colors of a particular hue belonging to the beige tone group or the gray tone group are shown with tone shading.

For example, on the swatch card 2 in FIG. 5(a), the sample nail colors of “baby pink” are arranged so that each tone is gradually diluted from the left side display parts 5 to the right side display parts 5. Similarly to the above, on the swatch card 2 in FIG. 5(b), the sample nail colors of “rose gray” are arranged with the sequential difference in tone.

These sample nail colors shown in the nail color swatch book 1 have effects that suit the skin colors of the Japanese and make the skin bright and beautiful, however, such color shades are difficult to express in words. Thus, when selecting and determining the nail color to be applied, it is possible to easily find the nail color that matches the image of the person to be treated by using the nail color swatch book 1. Furthermore, it is possible to easily share, between the practitioner and the person to be treated, the nail colors that have an effect of making the fingertips of the Japanese beautiful and that are proposed by the practitioner or meet the request of the person to be treated.

### Other Embodiments

As another embodiment, in the nail color swatch book 1 as illustrated in FIG. 6, no color is applied on the display parts 5 of the swatch card 2, and only the outlines of the display parts 5 are indicated. Such a swatch card 2 is preferably added to the nail color swatch book 1 as a spare sheet.

In this way, when it is needed to add sample nail colors or when new sample nail colors have been created, it is possible to apply or print such new sample nail colors on the display part 5 of the above-described swatch card 2 so as to incorporate it into the multiple swatch cards 2 constituting the nail color swatch book 1. Alternatively, nail decorations such as glitters may be shown on the display parts 5.

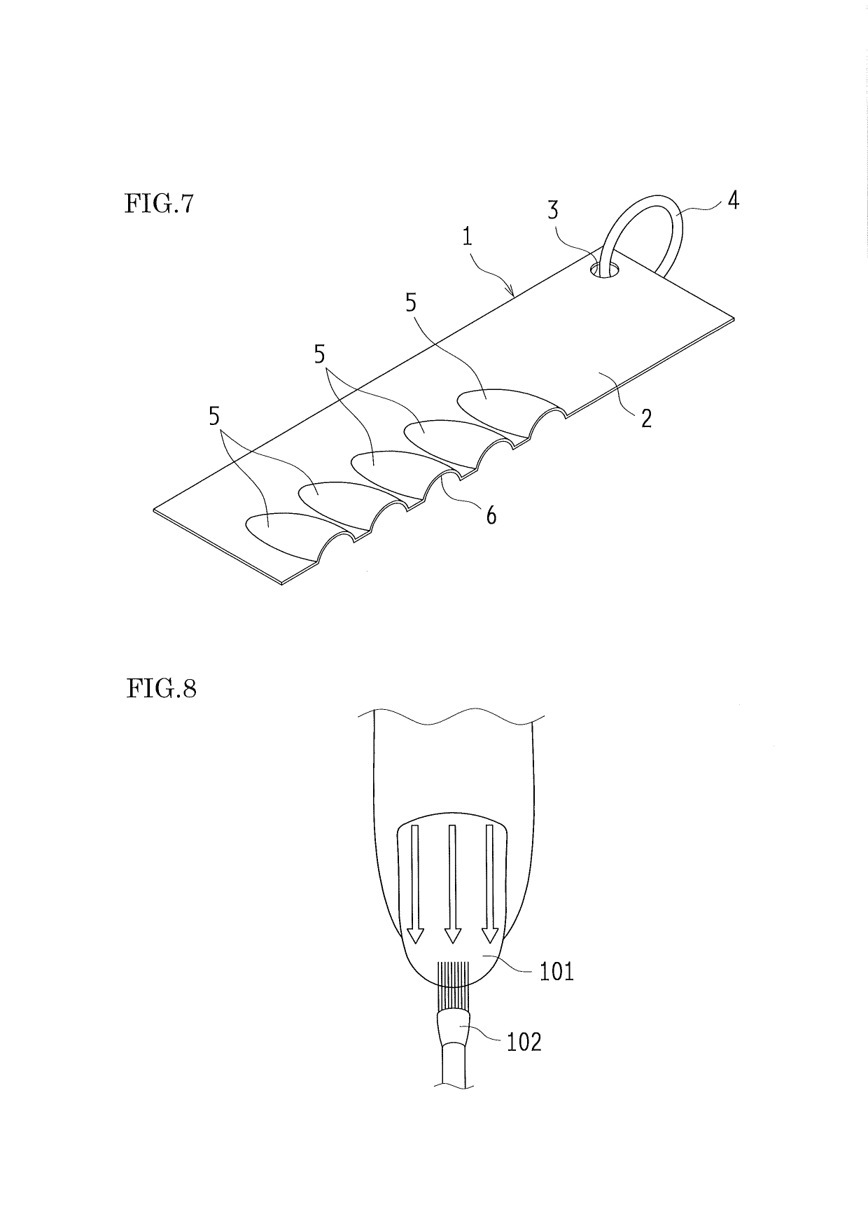

In the nail color swatch book 1 as illustrated in FIG. 7, the display parts 5 are sterically formed on the swatch card 2. Similarly to the previous embodiments, a plurality of swatch cards 2 (not shown) are piled up and bound by the ring 4 to make the nail color swatch book 1.

In this case, the display parts 5 are disposed on the swatch card 2 so as to each have a convex shape imitating a human-nail shape on the surface side of the swatch card 2. Furthermore, the display parts 5 are inclined toward the left side of the swatch card 2. Accordingly, on the reverse surface side of the display parts 5, dented nail-shaped concave parts 6 are formed. Thus, it is possible to fit the fingertips to the display parts 5 by putting the fingertips under the concave parts 6 on the reverse surface side of the display parts 5 of the swatch card 2.

In addition to showing the sample nail colors on the display parts 5 similarly to the previous embodiments based on a certain rule, the display parts 5 may include, for example, a plurality of sample nail colors and furthermore specific designs and patterns as nail designs. Also, nail decoration parts such as studs or artificial stones may be adhered to the convex surfaces of the display parts 5 so as to form samples of three-dimensional nail designs.

In contrast to the display parts 5 made up from various colors, it is preferable that the ground part of the swatch card 2 is transparent, semi-transparent or white. When the swatch card 2 is made of a transparent or semi-transparent plastic sheet-like material, the display parts 5 are integrally formed so as to each have a convex shape on the surface side of the swatch card 2. Since the swatch card 2 is transparent or semi-transparent, when the fingertips are put under the concave parts 6, the skin color can be seen from the part surrounding the display parts 5 while the display parts 5 can be seen in the state in which they are overlapped with the fingernails of the person to be treated. It further facilitates consideration or determination of the nail color, and also it is possible to easily share the specific image between the practitioner and the person to be treated.

As described above, the nail color swatch book 1 of the present invention is simple and easy to handle when the nail art treatment is performed, which is suitably used as a basis for decision and a material for consideration in order to determine the color of the nail agent to be applied. Note that, in the nail color swatch book 1, the sample nail colors shown on the display parts 5 are not limited to the colors as described in the previous embodiments. Any other sample nail colors may be shown.

The present invention may be embodied in other forms without departing from the gist or essential characteristics thereof. The foregoing embodiments are therefore to be considered in all respects as illustrative and not limiting. The scope of the invention is indicated by the appended claims rather than by the foregoing description, and all modifications and changes that come within the meaning and range of equivalency of the claims are intended to be embraced therein.

This application claims priority based on Patent Application No. 2016-081228 filed in Japan on Apr. 14, 2016. The entire contents thereof are hereby incorporated in this application by reference.

### INDUSTRIAL APPLICABILITY

The present invention can be suitably used for gel nail art treatment.

### DESCRIPTION OF REFERENCE NUMERALS

1 Nail color swatch book
2 Swatch card
3 Round hole
4 Ring
5 Display parts
6 Concave part

1. A nail color swatch book showing nail colors, comprising:
a plurality of sheet-like swatch cards; and a binding member binding the plurality of swatch cards into one bundle,
wherein the plurality of swatch cards each includes a plurality of display parts showing sample nail colors,
wherein the plurality of display parts each has a shape imitating a human-nail shape, and is arranged along a side edge part of each of the swatch cards, and
wherein respective bases of the human-nail like shapes of the display parts are arranged so as to make contact with the side edge part of each of the swatch cards while respective center lines of the human-nail like shapes in a height direction are disposed so as to incline relative to an edge line of the side edge part of each of the swatch cards.

2. A nail color swatch book showing nail colors, comprising:
a plurality of sheet-like swatch cards; and a binding member binding the plurality of swatch cards into one bundle,
wherein the plurality of swatch cards each includes a plurality of display parts showing sample nail colors,
wherein the plurality of display parts each has a shape imitating a human-nail shape, and is arranged along a side edge part of each of the swatch cards,
wherein the display parts on each of the swatch cards indicate different hues in a same lightness or a same saturation, and
wherein the plurality of swatch cards is overlapped and bound one by one in an order of the lightness or the saturation of the display parts.

3. A nail color swatch book showing nail colors, comprising:
a plurality of sheet-like swatch cards; and a binding member binding the plurality of swatch cards into one bundle,
wherein the plurality of swatch cards each includes a plurality of display parts showing sample nail colors,
wherein the plurality of display parts each has a shape imitating a human-nail shape, and is arranged along a side edge part of each of the swatch cards,
wherein the display parts on each of the swatch cards indicate different hues in a same tone, and
wherein the plurality of swatch cards is piled up to be bound so that the swatch cards similar to each other in the tone of the display parts are sequentially overlapped.

4. The nail color swatch book according to claim 1,
wherein the display parts of each of the swatch cards are arranged so as to each have a tone different from one another in a same hue or similar hues.

5. The nail color swatch book according to claim 1,
wherein the display parts of each of the swatch cards are arranged so as to each have a lightness different from one another in a same hue or similar hues.

6. The nail color swatch book according to claim 1,
wherein the display parts of each of the swatch cards are arranged so as to each have a saturation different from one another in a same hue or similar hues.

7. The nail color swatch book according to claim 2,
wherein respective bases of the human-nail like shapes of the display parts are arranged so as to make contact with the side edge part of each of the swatch cards while respective center lines of the human-nail like shapes in a height direction incline relative to an edge line of the side edge part of each of the swatch cards.

8. The nail color swatch book according to claim 1,
wherein the display parts are disposed so as to each have a convex shape on a surface side of each of the swatch cards while concave parts are disposed on a reverse surface side of the display parts so that fingertips are fit to the concave parts.

9. The nail color swatch book according to claim 1,
wherein ground part of each of the swatch cards is transparent or semi-transparent.

10. The nail color swatch book according to claim 1,
wherein the sample nail colors on the display parts are classified and collected, for every bundle of the swatch cards, into one of four season groups constituted by a spring group, a summer group, an autumn group and a winter group.

11. The nail color swatch book according to claim 3,
wherein respective bases of the human-nail like shapes of the display parts are arranged so as to make contact with the side edge part of each of the swatch cards while respective center lines of the human-nail like shapes in a height direction incline relative to an edge line of the side edge part of each of the swatch cards.

12. The nail color swatch book according to claim 2,
wherein the display parts are disposed so as to each have a convex shape on a surface side of each of the swatch cards while concave parts are disposed on a reverse surface side of the display parts so that fingertips are fit to the concave parts.

13. The nail color swatch book according to claim 3,
wherein the display parts are disposed so as to each have a convex shape on a surface side of each of the swatch cards while concave parts are disposed on a reverse surface side of the display parts so that fingertips are fit to the concave parts.

14. The nail color swatch book according to claim 2,
wherein ground part of each of the swatch cards is transparent or semi-transparent.

15. The nail color swatch book according to claim 3,
wherein ground part of each of the swatch cards is transparent or semi-transparent.

16. The nail color swatch book according to claim 2,
wherein the sample nail colors on the display parts are classified and collected, for every bundle of the swatch cards, into one of four season groups constituted by a spring group, a summer group, an autumn group and a winter group.

17. The nail color swatch book according to claim 3,
wherein the sample nail colors on the display parts are classified and collected, for every bundle of the swatch cards, into one of four season groups constituted by a spring group, a summer group, an autumn group and a winter group.
